(19) United States
(12) Patent Application Publication
(10) Pub. No.: US 2026/0107053 A1
(43) Pub. Date: Apr. 16, 2026

(54) SYSTEMS AND METHODS FOR CALIBRATING A FOCUS OF IMAGE CAPTURE DEVICES TO CAPTURE IMAGES OF PERISHABLE CONSUMER PRODUCTS

(71) Applicant: Walmart Apollo, LLC, Bentonville, AR (US)

(72) Inventors: Harinarayanan Kuruthikadavath Kurussithodi, Palakkad (IN); Dhiraj Dhananjay Daga, Bangalore (IN); Anju Das B, Bangalore (IN); Raghuram Sathyamurthy, Salem (IN); Soumabrata Arup Chakraborty, Pune (IN); Sudipta Kumar Das, Bengaluru (IN); Lokesh Kumar Sambasivan, Tirupati (IN); Maxine Caballero Perales, Jacksonville, FL (US); Chuck E. Tilmon, Rogers, AR (US); Michael Jason Klingman, Gentry, AR (US); Jeffery R. Montgomery, Cave Springs, AR (US)

(21) Appl. No.: 19/357,389

(22) Filed: Oct. 14, 2025

Related U.S. Application Data
(60) Provisional application No. 63/706,890, filed on Oct. 14, 2024.

(51) Int. Cl. H04N 23/61; G06T 7/00; G06T 7/20; G06T 7/70; G06T 7/80; G06V 10/12; G06V 10/764; G06V 20/68; H04N 23/60; H04N 23/67; H04N 23/90

(52) U.S. Cl. CPC H04N 23/61; G06T 7/0004; G06T 7/20; G06T 7/70; G06T 7/80; G06V 20/68; H04N 23/64; H04N 23/67; H04N 23/90; G06T 2207/30128; G06V 10/12; G06V 10/764

(57) ABSTRACT

A system for calibrating the focus of image capture devices positioned to capture images of products is disclosed. The system includes a product support surface, at least one image capture device, and a control circuit. The control circuit receives an input indicating a product is positioned within the image capture device's field of view, identifies the product's type and/or size, and then adjusts the image capture device's lens to a focus complementary to the identified product type and/or size. A method is also disclosed, involving supporting a product, capturing an image, detecting its presence, identifying its type/size, and adjusting the lens focus for optimal image capture. This enables the acquisition of maximally focused images for efficient and precise quality assessment of perishable consumer products.

### CROSS-REFERENCE TO RELATED APPLICATIONS

This application claims the benefit of U.S. Provisional Application No. 63/706,890, filed Oct. 14, 2024, which is incorporated herein by reference in its entirety.

### TECHNICAL FIELD

This disclosure generally relates to assessment of perishable product quality and, more particularly, to assessing the quality of consumable products detected in digital images thereof.

### BACKGROUND

The assessment of perishable product quality, particularly for consumable products detected in digital images, presents significant challenges. Traditional methods for inspecting perishable consumer products, such as fruits, vegetables, medications, and dietary supplements, often rely on manual inspection, which is prone to human error, inconsistency, and is labor-intensive. Automated inspection systems, while offering efficiency, face difficulties in consistently capturing high-quality images of products, especially when those products are moving on conveyors and vary in type, size, and shape.

Achieving optimal focus for image capture devices is important for accurate detection and identification of products, as well as for precise identification of defects and damage on their surfaces, which is essential for effective quality assessment and commercial viability. Without proper focus calibration, images may lack the clarity required for reliable machine vision analysis, leading to inaccurate quality determinations and potential economic losses for retailers.

### BRIEF DESCRIPTION OF THE DRAWINGS

Disclosed herein are embodiments of systems and methods for capturing images of perishable consumable products while the products are moving on conveyors, and then assessing the quality of the consumable products detected in the images. This description includes drawings, wherein:

FIG. 1 is a perspective view of an example system for capturing images of a plurality of products and assessing their quality in accordance with some embodiments;

FIG. 2 is a front view of the system of FIG. 1, further illustrating a container for receiving products in accordance with some embodiments;

FIG. 3 is a schematic view of an example setup of the system of FIG. 1 for calibrating a focus of image capture devices, illustrating various dimensions and component arrangements in accordance with some embodiments;

FIG. 4 is a block diagram illustrating an example system for capturing images and assessing product quality, including a computing device, electronic database, and network connectivity in accordance with some embodiments;

FIG. 5 is a block diagram illustrating an example computing device used in the systems and methods disclosed herein in accordance with some embodiments;

FIG. 6 is a block diagram illustrating an example system including a settings loader, focus estimator, product detector, and tracker for calibrating image capture device settings in accordance with some embodiments;

FIG. 7 is a flow chart depicting an example method for calibrating a focus of image capture devices positioned to capture images of a plurality of products in accordance with some embodiments.

FIG. 8 is a flow chart depicting an example method for calibrating a focus of image capture devices positioned to capture images of a plurality of products in accordance with some embodiments

FIG. 9 is a flow chart depicting an example method for calibrating a focus of image capture devices positioned to capture images of a plurality of products in accordance with some embodiments; and

FIG. 10 is a flow chart depicting an example method for calibrating a focus of image capture devices positioned to capture images of a plurality of products in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems and methods are provided for capturing images of perishable consumable products while the products are moving on conveyors, and then assessing the quality of the consumable products detected in the images.

The following description is not to be taken in a limiting sense, but is made merely for the purpose of describing the general principles of example embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In one embodiment, a system for calibrating a focus of image capture devices positioned to capture images of a plurality of products includes: a product support surface that supports at least one product of the plurality of products thereon; at least one image capture device positioned proximate the product support surface to capture at least one image of the at least one product from at least one perspective; and a control circuit including a programmable processor and communicatively coupled to the at least one image capture device. The control circuit: receives an input indicating that the at least one product located on the product support surface is positioned within a field of view of the at least one image capture device; identifies at least one of a type and size of the at least one product positioned within the field of view of the at least one image capture device; and based on an identification, by the control circuit, of the at least one of the type and size of the at least one product positioned within the field of view of the at least one image capture device, causes a lens of the at least one image capture device to adjust to a focus that is complementary to the at least one of the type and size of the at least one product positioned within the field of view of the at least one image capture device.

In another embodiment, a method for calibrating a focus of image capture devices positioned to capture images of a plurality of products includes: supporting at least one product of the plurality of products on a product support surface; capturing, by at least one image capture device positioned proximate the product support surface, at least one image of the at least one product from at least one perspective; and by a control circuit including a programmable processor and communicatively coupled to the at least one image capture device: receiving an input indicating that the at least one product located on the product support surface is positioned within a field of view of the at least one image capture device; identifying at least one of a type and size of the at least one product positioned within the field of view of the at least one image capture device; and based on an identification, by the control circuit, of the at least one of the type and size of the at least one product positioned within the field of view of the at least one image capture device, causing a lens of the at least one image capture device to adjust to a focus that is complementary to the at least one of the type and size of the at least one product positioned within the field of view of the at least one image capture device.

In yet another embodiment, a non-transitory computer-readable medium programmed with a computer-executable instructions for calibrating at least one image capture device proximate a product support surface to capture images of at least one product located on the product support surface from at least one perspective, wherein the instructions are executed by a control circuit to cause the control circuit to: receive an input indicating that at least one product located on the product support surface is positioned within a field of view of the at least one image capture device; identify at least one of a type and size of the at least one product positioned within the field of view of the at least one image capture device; and based on an identification, by the control circuit, of the at least one of the type and size of the at least one product positioned within the field of view of the at least one image capture device, cause a lens of the at least one image capture device to adjust to a focus that is complementary to the at least one of the type and size of the at least one product positioned within the field of view of the at least one image capture device.

Generally speaking, a product inspection system includes components, such as a camera, a lens (notably, as used herein, the term “image capture device,” discussed in more detail below, includes a camera and a lens), computing device, and other physical hardware. A camera may be defined by a large number of parameters, but example, the sensor type (CMOS, CCD, SCOMOS etc.), sensor model (IMX273, CMV12000, etc.), distance between pixels (i.e., pixel pitch), characteristics of sensor noise (e.g., dark, current etc.), and the like. The parameters that are relevant to a camera of product inspection systems in accordance with some embodiments described below include but are not limited to: sensor size (which denotes the size of sensor inside camera and may include both the length and the width of the sensor); sensor resolution (i.e., the number of pixels in the sensor); pixel size (which denotes the size of each pixel in the sensor, and which may include the length and width of each pixel); frames per second (which denotes the number of frames a camera can capture in a second); and connectivity (e.g., USB 3.0, GigE, CoaXPress, etc.), and shutter type (which may be global or rolling, or rolling with global reset).

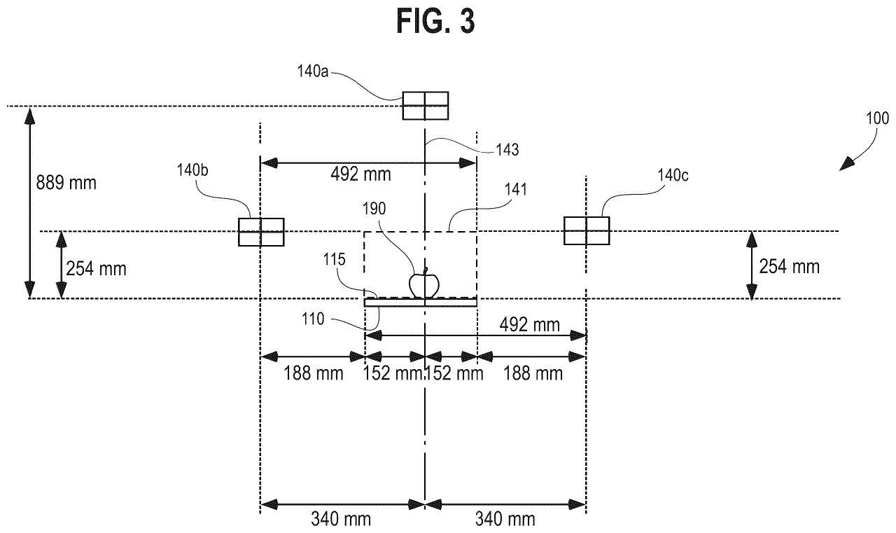

Generally, the lens of a camera is defined by a number of parameters. The parameters that are relevant to a lens of product inspection systems in accordance with some embodiments described below include but are not limited to: focal length (i.e., distance at which the rays from infinity will converge behind the lens); working distance (i.e., distance between the object being photographed and the lens of the camera at which the object will be in focus at the sensor); field of view (i.e., the area the lens has to project to the sensor; notably, the field of view may be represented as the length and width of a specific area (see, e.g., FIG. 3 below); depth of field (i.e., the depth of the volume along the optical axis); aperture (i.e., the light collection power of the lens, which may be controlled by varying the iris diameter); camera mount (i.e., a complementary connection mechanism to the camera); and supported sensor size (e.g., each camera lens will have a cone of projection that is matched with the sensor to get the maximum possible field of view).

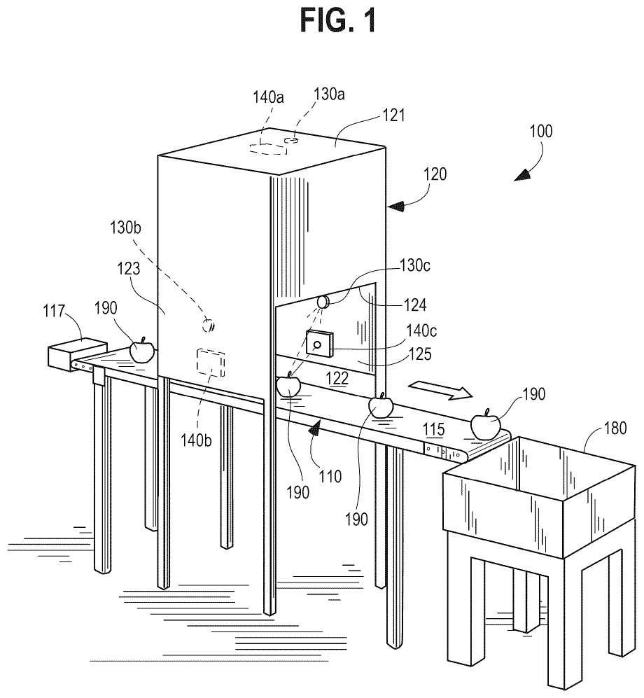

FIG. 1 shows an embodiment of a system 100 for capturing images of a plurality of products 190 and assessing the quality of the products 190. Example products 190 may include, but are not limited to, any general-purpose consumer goods, as well as consumable and perishable products, such as, for example, food/grocery/beverage items (e.g., fruits, vegetables, etc.), medications, and dietary supplements.

The example system 100 shown in FIG. 1 is a conveyor-based system, where the products 190 move on a product advancement surface 115 of a conveyor 110, and the image capture devices 140a-140c (e.g., cameras) are positioned proximate the product advancement surface 115 of the conveyor 110 such that the products 190 moving on the conveyor 110 pass through a field of view of the image capture devices 140a-140c. However, it will be appreciated that, in some implementations, the system 100 does not include a conveyor, and the products 190 are positioned on and remain stationary on a product support surface that does not move, and the image capture devices 140a-140c are aimed at, and capture images of the products 190 while the products 190 remain stationary on the non-moving product support surface.

The system 100 is shown in FIG. 1 for simplicity of illustration with only one conveyor 110 having four identical products 190 (in this example, apples) thereon passing through one housing 120, but it will be appreciated that the system 100 may include more than one housing 120 and more than one conveyor 110 that may transport more than four products 190 thereon (e.g., dozens and/or hundreds of products 190, depending on the length of the conveyor 110). Further, the type, size, and shape of the products 190 in FIG. 1 has been shown by way of example only, and it will be appreciated that the conveyors 110 may transport many different products 190 having many different sizes and shapes.

The conveyor 110 has a product advancement surface 115 that moves one or more products 190 in a first direction indicated by the directional arrow. The product advancement surface 115 of the conveyor 110 may include a single conveyor belt surface (horizontal (as shown) or inclined), or may be instead comprised of a series of two or more independently movable conveyor belt surfaces (horizontal or inclined). The conveyor 110 may be a belt conveyor, chain conveyor, or the like and may have a continuous, uninterrupted product advancement surface 115, or may have a product advancement surface 115 that includes one or more interruptions at the transitions between the distinct conveyor surfaces.

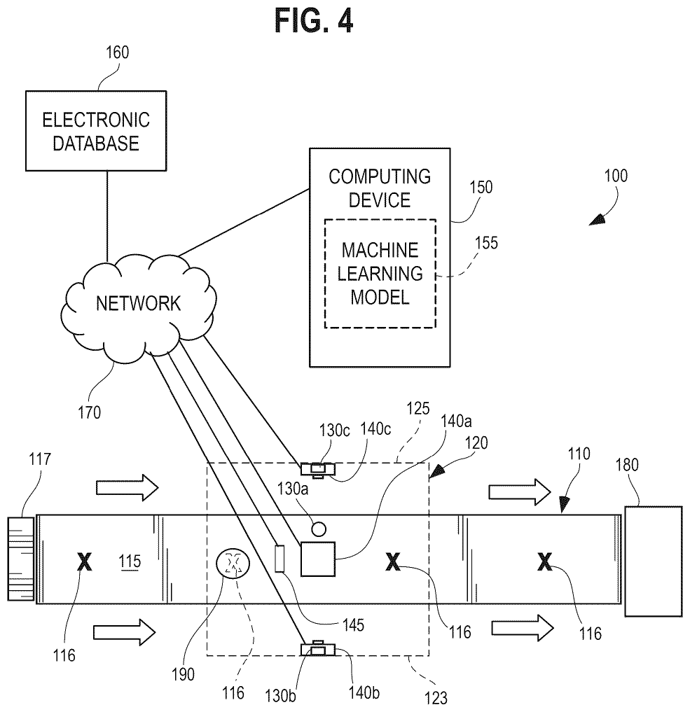

In some embodiments, the product advancement surface 115 of the conveyor 110 includes one or more sets of markings 116 indicating an expected location of the products 190 on the product advancement surface 115 of the conveyor 110 during the movement of the products 190 on the conveyor 110. For example, as shown in FIG. 4, the example markings 116 on the product advancement surface 115 of the conveyor 110 may include a marking in the form of a cross or an “X,” and the products 190 that are loaded onto the conveyor 110 (by a hand of a human operator or by a mechanical/electronic hand of a robot) are placed on the center of the X. It will be appreciated that other markings 116 may be used instead of crosses/X's, for example, dots, circles, lines, and the like.

In some embodiments, the product advancement surface 115 may include a product stopper that retains (i.e., restricts from moving) the products 190 placed on the product advancement surface 115 in a specified position and within a specified area (e.g., within the field of view (identified by a dashed rectangle 141 in FIG. 3) of the image capture devices 140a-140c and in an optimal position/orientation for the capturing of the images of the product 190 such that any defect on the surface of the product 190 faces one or more of the image capture devices 140a-140c). The product stopper may be transparent to permit the image devices 140a-140c to capture images of the product 190 therethrough, and may comprise any suitable structure, mechanism, or device for retaining the product on the product advancement surface 115. For example, the product stopper may include a ledge, a ridge, a wall, or the like.

Notably, in certain embodiments described herein, the optimal position/orientation for the capturing of the images of the product 190 such that any defect on the surface of the product 190 faces one or more of the image capture devices 140a-140c) is assumed to be at the center (identified by the dashed vertical line 143 in FIG. 3) of the field of view (identified by the dashed rectangle 141 in FIG. 3) of the image capture devices 140a-140c. Examples of systems, where the image capture devices 140a-140c are not set to continuously snap digital (photo and/or video) images of the conveyor 110 at a preset frame rate the whole time while the conveyor 110 is moving, but are caused to snap a digital image only at a time when a computing device of the system estimates that the product 190 moving on the conveyor 110 has arrived to a center of the field of view of the image capture devices 140a-140c pointed at the conveyor 110 are described in co-pending U.S. provisional application filed concurrently herewith, Application No. . . . , entitled “CONVEYOR-BASED SYSTEMS AND METHODS FOR CAPTURING IMAGES TO ASSESS QUALITY OF PERISHABLE CONSUMER PRODUCTS,” attorney docket number 8842-159847-USPR-8773US01, incorporated herein by reference in its entirety.

In order to effectuate the directional movement of the product advancement surface 115 of the conveyor 110 and the movement of the products 190 thereon, the example system 100 illustrated in FIG. 1 includes a conveyor control unit 117 coupled (e.g., electrically) to the conveyor 110. The conveyor control unit 117 can be located at or near the conveyor 110 as shown in FIG. 1, or may be built into the conveyor 110. In some embodiments, the conveyor control unit 117 receives a signal from a computing device 150 (which is shown in FIG. 4 and will be described in more detail below) and, in response to receipt of such a signal, to either cause the product advancement surface 115 to move in the direction shown by directional arrows in FIG. 1 (or in an opposite direction), or to stop.

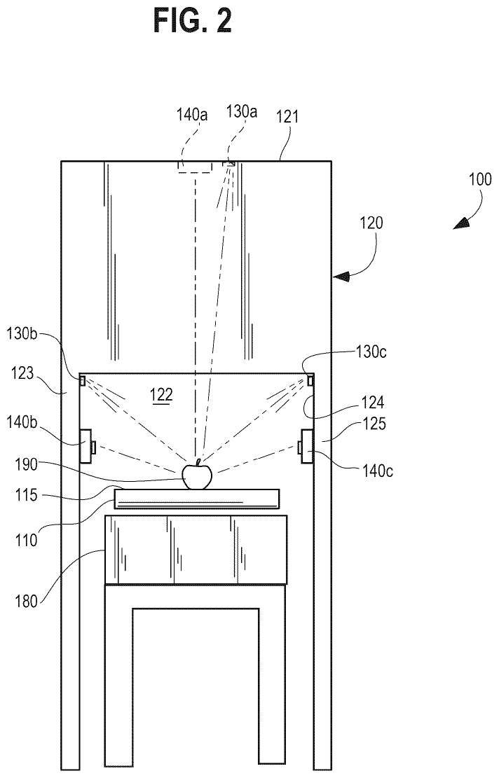

In the illustrated embodiment (see, e.g., FIGS. 1, 2, and 4), the system 100 further includes a container 180 (e.g., a tote, box, bag, or the like) positioned downstream of the end of the conveyor that is opposite to the end where the control unit 117 is located, and this container 180 is positioned to receive the products 190 as they come off the conveyor 110. In other words, with reference to FIG. 1, if the container 180 were not present at the location shown in FIG. 1, the products 190 would either have to be picked off by hand from the conveyor 110, or they would simply fall off the conveyor 110.

The example system 100 shown in FIG. 1 includes a housing 120 arranged to overlay the product advancement surface 115 of the conveyor 110. Notably, both the conveyor 110 and the housing 120 are optional, since, in some embodiments, the system 100 is implemented such that a product 190 is placed on a product support surface that does not move and that does not have a housing overlaying it, and one or more image capture devices 140a-140c are positioned proximate the product support surface to capture one or more images of the product 190.

The housing 120 of the example system 100 shown in FIG. 1 includes an interior 122 that functions akin to a tunnel and an opening 124 that permits the products 190 to pass through the interior 122 of the housing 120 while traveling on the product advancement surface 115 of the conveyor 110. The example housing 120 includes a top wall 121, and opposing side walls (i.e., a first side wall 123 and a second side wall 125 opposite the first side wall 123). In the illustrated embodiment, the housing 120 overlays only a portion of the product advancement surface 115 of the conveyor 110, but it will be appreciated that the housing 120 may be constructed such that it overlays the entire product advancement surface 115 of the conveyor 110. It will also be appreciated that the housing 120 is not required in all embodiments of the system 100, and that, in some embodiments, components of the system 100 such as lighting elements 130a-130c and image capture devices 140a-140c may be coupled/mounted to the conveyor 110 or structures proximate to the conveyor 110 instead of being coupled to a housing 120.

As shown in FIG. 1, the example system 100 may include one or more lighting elements 130a-130c located proximate the product advancement surface 115 of the conveyor 110 and positioned/oriented to provide illumination onto the product advancement surface 115 from at least one side. The lighting elements 130a-130c can be of any suitable type (e.g., incandescent, fluorescent, LED, etc.) and can produce light that is visible and/or invisible to the human eye. The example system illustrated in FIG. 1 includes three lighting elements 130a, 130b, and 130c, with a first of the lighting elements 130a being positioned above (and directly overlaying) the product advancement surface 115, a second of the lighting elements 130b being positioned on a first side of the product advancement surface 115 of the conveyor 110, and a third of the lighting elements 130c being positioned on a second side of the product advancement surface 115 of the at least one conveyor 110 that is opposite to the first side.

In particular, in the embodiment shown in FIG. 1, the first lighting element 130a is coupled to (or otherwise positioned at) the top wall 121 of the housing 120, the second lighting element 130b is coupled to (or otherwise positioned at) the first side wall 123 of the housing 120, and the third lighting element 130c is coupled to (or otherwise positioned at) the second side wall 125 of the housing 120. However, it will be appreciated that the system 100 may include three lighting elements 130a-130c positioned in various different locations, only one lighting element 130a-130c, two lighting elements 130a-130c, more than three lighting elements 130a-130c, or no lighting elements at all (e.g., if the ambient conditions do not require additional lighting).

The example system 100 shown in FIG. 1 further includes one or more image capture devices 140a-140c positioned proximate the product advancement surface 115 of the conveyor 110 to continuously capture at least one image of the product advancement surface 115 of the conveyor 110 from at least one perspective. The term “continuously capture” as used herein means that the image capture devices 140a-140c are preset to snap digital images of the conveyor 110 at a preset frame rate the whole time while the conveyor 110 is moving, and are not caused to snap a digital image only in response to a signal (e.g., a signal that may be sent by a proximity sensor, motion detector, etc.) that indicates the detection of a product 190 on the conveyor 110 (or within a field of view of the image capture devices 140a-140c).

Some examples of conveyor-based systems, where the image capture devices 140a-140c are set to continuously snap (at a pre-defined frame rate, e.g., from 1 to 10 frames per second) digital images of the conveyor 110 at a preset frame rate the whole time while the conveyor 110 is moving, and are not caused to snap a digital image only in response to detection (e.g., by an object-detecting sensor, etc.) of a product 190 on the conveyor 110 are described in co-pending U.S. provisional application filed concurrently herewith, Application No. . . . , entitled “CONVEYOR-BASED SYSTEMS AND METHODS FOR ASSESSING QUALITY OF PERISHABLE CONSUMER PRODUCTS,” attorney docket number 8842-159583-USPR-8722US01, incorporated herein by reference in its entirety.

The system 100 according to the embodiment illustrated in FIG. 1 includes three image capture devices 140a, 140b, and 140c, with a first of the image capture devices 140a being positioned above (and directly overlaying) the product advancement surface 115, a second of the image capture devices 140b being positioned on a first side of the product advancement surface 115 of the conveyor 110, and a third of the image capture devices 140c being positioned on a second side of the product advancement surface 115 of the at least one conveyor 110 that is opposite to the first side. Specifically, as shown in FIG. 1, the first image capture device 140a is coupled to (or otherwise positioned at) the top wall 121 of the housing 120, the second image capture device 140b is coupled to (or otherwise positioned at) the first side wall 123 of the housing 120, and the third image capture device 140c is coupled to (or otherwise positioned at) the second side wall 125 of the housing 120. However, it will be appreciated that the system 100 may include three image capture devices 140a-140c positioned in various different locations, only one image capture device 140a-140c, or two image capture devices 140a-140c, or more than three image capture devices 140a-140c.

With reference to FIGS. 1 and 4, as will be described in more detail below, one or more images of one or more products 190 located on the product advancement surface 115 of the housing 120 captured by one or more image capture devices 140a-140c are transmitted by the image capture devices 140a-140c over a network 170 to an electronic database 160 and/or to a computing device 150. The example network 170 depicted in FIG. 4 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based computer vision application programming interfaces (APIs) and cloud-based memory storage.

In some embodiments, the system 100 includes a product detector sensor 145 positioned proximate the product advancement surface 115 of the conveyor 110 to detect the presence and/or location of the product 190 moving on the product advancement surface 115 of conveyor 110, and generate product location data indicating at least one of the presence and the location of the product 190 on the product advancement surface 115 of the conveyor 110. In the example embodiment illustrated in FIG. 4, the system 100 is shown with only one product detector sensor 145 mounted to the housing 120, but it will be appreciated that the system 100 may include more than one product detector sensor 145 positioned along (e.g., on either side of or above) the product advancement surface 115 of the conveyor 110, and this sensor may be located separately from (i.e., unattached to) the housing 120.

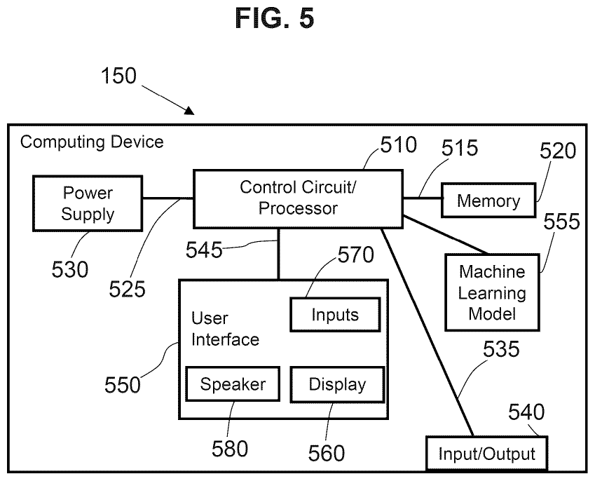

In certain embodiments, while a product 190 is moving on a conveyor 110, the product detector sensor 145 detects a presence of the product 190 at the center (see vertical line 143 in FIG. 3) of the field of view (see dashed rectangle 141 in FIG. 3) of the image capture devices 140a-140c. In one implementation, in response to the product detector sensor 145 transmitting a signal that includes product location data indicating that the product 190 is located at the center 143 of the field of view 141 of the image capture devices 140a-140c, the control circuit 510 of the computing device 150 (see FIG. 5) causes the conveyor 110 to stop. According to some embodiments, the product detector sensor 145 can include one or more sensors including, but not limited to, a motion-detecting sensor, physical contact sensor, barcode-scanning sensor, RFID-detecting sensor, digital camera sensor, or the like.

With reference to FIG. 1, the example system 100 includes an electronic database 160. In some embodiments, the electronic database 160 and the computing device 150 may be implemented as two separate physical devices. It will be appreciated, however, that the computing device 150 and the electronic database 160 may be implemented as a single physical device. In addition, while FIG. 4 shows that the electronic database 160 and the computing device 150 are separate and distinct from the housing 120, it will be appreciated that the computing device 150 and/or electronic database 160 may be physically coupled to or otherwise incorporated into the physical structure of the housing 120. In some embodiments, the electronic database 160 may be stored, for example, on non-volatile storage media (e.g., a hard drive, flash drive, or removable optical disk) internal or external to the computing device 150, or internal or external to computing devices distinct from the computing device 150. In some embodiments, the electronic database 160 may be cloud-based.

Generally, the example electronic database 160 of FIG. 4 is stores data associated with images of the products 190 captured by the image capture devices 140a-140c. Some example electronic data that may be stored in the electronic database 160 includes but is not limited to electronic data corresponding to captured image data and/or reference model image data associated with the products 190 offered for sale by the retailer and representing the products 190 at varying focus and from various view perspectives (e.g., top, bottom, side, etc.), and in various sizes (e.g., small, medium, large, extra-large) and various quality states (e.g., acceptable, not acceptable, somewhat damaged but acceptable, damaged to an unacceptable degree, including a small defect but acceptable, including a defect large enough to make the product unacceptable, etc.).

In some embodiments, the electronic database 160 stores a set of one or more government regulations such as FDA regulations, USDA regulations, industry standards, corporate policies, or the like data indicating the governing standard for what is an acceptable product 190 and what is not an acceptable product 190. For example, the electronic database 160 may store predefined specifications defined by the USDA with respect to consumable product quality standards, and which may define the maximum possible degree of defect/damage on a surface of a given consumable product 190 (e.g., produce) that may be acceptable for a retailer to sell to a consumer by a retailer.

The example system 100 of FIG. 4 further includes a computing device 150 that communicates with the electronic database 160, the image capture devices 140a-140c, and the lighting elements 130a-130c (and any other electronic components of the system 100) over the network 170. The computing device 150 may be a stationary or portable electronic device, for example, a desktop computer, a laptop computer, a tablet, a mobile phone, or any other electronic device including a control circuit (i.e., control unit) that includes a programmable processor. The computing device 150 may provide for data entry and processing as well as for communication with other devices of system 100 via the network 170.

As will be discussed in more detail below, the computing device 150 may to receive an input indicating that a product 190 located on the product advancement surface 115 (i.e., the product support surface) of the conveyor 110 is positioned within a field of view 141 (and, preferably, at the center 143 of the field of view 141) of at least one image capture device 140a-140c, which allows the computing device 150 to identify a type and/or a size of the product 190 positioned within the field of view 141 of the image capture device 140a-140c. Then, based on the identification of this product 190 by the computing device 150, the computing device 150 causes (e.g., by sending a control signal) a lens of the image capture device 140a-140c to adjust to a focus that is complementary to the type and/or size of the product 190 positioned within the field of view of the image capture device 140a-140c.

With reference to FIG. 4, the computing device 150 may execute a machine learning model 155, which enables the computing device 150 to improve at least one of: (1) determination that a product 190 travelling on the product advancement surface 115 of the conveyor 110 is located at the center 143 of the field of view 141 of the image capture devices 140a-140c; (2) identification of products 190 moving on the conveyor 110; and (3) detection of defects on a surface of the products 190 moving on the conveyor 110. As mentioned above, the computing device 150 may be located at the same physical location as the electronic database 160, or at a location remote relative to the electronic database 160, and may be separate from the housing 120 or coupled to or physically incorporated into the structure of the housing 120.

FIG. 3 shows an example set up of the system 100 for calibrating a focus of image capture devices 140a-140c positioned to capture images of a plurality of products 190 in order to assess the quality of the products 190, which as mentioned above, may be of different types, shapes, and sizes. In some embodiments, the size of the products 190 that may be moved on the conveyor 110 of the system 100 to permit the image capture devices 140a-140c to snap digital images thereof may be, for example, up to 300 mm in length, up to 200 mm in width, and up to 250 mm in height. It will be appreciated that the system 100 may be set up to process products 190 that are larger in size, if needed.

In the embodiment shown in FIG. 3, the width of the conveyor 110 is 304 mm (which is shown in FIG. 3 by an indication that the distance from each edge of the conveyor 10 to the dashed vertical line 143 (representing the center of the field of view of the image capture devices 140a-140c) in a direction perpendicular to this vertical line 143 is 152 mm), but it will be appreciated that the width of the conveyor 110 may be varied, if needed. In certain embodiments, the control unit 117 causes the conveyor 110 to move at a speed of at least 76 mm/s, but it will be appreciated that the speed of the conveyor 110 may be reduced to below 76 mm/s, if needed in certain circumstances. As mentioned above, the system 100 has three image capture devices 140a-140c (i.e., cameras) positioned proximate the conveyor 110 and aimed at the conveyor 110, such that each product 190 moving on the conveyor 110 passes through the field of view of the cameras 140a-140c (which is indicated by a dashed rectangle 143 in FIG. 3).

In the example embodiment shown in FIG. 3, the center of the lens (shown by two crossing solid lines in FIG. 3) of the top image capture device 140a is aligned with the vertical line 143 passing perpendicularly through the product advancement surface 115 of the conveyor 110. In addition, the center of the lens of the top image capture device 140a is located 889 mm above the product advancement surface 115 of the conveyor 110 when measured along the vertical line 143 passing through the product advancement surface 115 of the conveyor 110. As shown in FIG. 3, the center of the lens of each of the first side image capture device 140b and the second side image capture device 140c is located 254 mm above the product advancement surface 115 of the conveyor when measured along a line (shown in dash in FIG. 3) parallel to the vertical line 143 passing through the product advancement surface 115 of the conveyor 110.

The center of the lens of the first side image capture device 140b is located on one side of the conveyor 110 at a distance of 340 mm from the vertical line 143, when measured along a line (shown in dash in FIG. 3) perpendicular to the vertical line 143. The center of the lens of the first side image capture device 140b is also spaced by a distance of 188 mm from an edge of the conveyor 110 that is closer to the image capture device 140b (and further away from the image capture device 140c), when measured along a line (shown in dash in FIG. 3) perpendicular to the vertical line 143. The center of the lens of the first side image capture device 140b is also spaced by a distance of 492 mm from an edge of the conveyor 110 that is further away from the image capture device 140b (and closer to the image capture device 140c), when measured along a line (shown in dash in FIG. 3) perpendicular to the vertical line 143.

Similarly, the center of the lens of the second side image capture device 140c is located on a second (opposite) side of the conveyor 110 at a distance of 340 mm from the vertical line 143, when measured along a line (shown in dash in FIG. 3) perpendicular to the vertical line 143. The center of the lens of the second side image capture device 140c is also spaced by a distance of 188 mm from an edge of the conveyor 110 that is closer to the image capture device 140c (and further away from the image capture device 140b), when measured along a line (shown in dash in FIG. 3) perpendicular to the vertical line 143. The center of the lens of the second side image capture device 140c is also spaced by a distance of 492 mm from an edge of the conveyor 110 that is further away from the image capture device 140c (and closer to the image capture device 140b), when measured along a line (shown in dash in FIG. 3) perpendicular to the vertical line 143.

According to the example setup of the system 100 as shown in FIG. 3, the field of view 141 of the image capture devices 140a-140c is defined by the dashed rectangle having long opposing sides that are oriented perpendicularly to the vertical line 143 and have a length of 304 mm and are bisected by the vertical line 143 (creating a segment of 152 mm on each side of the vertical line 143). Additionally, the dashed rectangle representing the field of view 141 of the image capture devices 140a-140c in FIG. 3 has short opposing sides that are oriented in parallel to the vertical line 143 and have a length of 254 mm. Notably, FIG. 3 shows example locations of the image capture devices 140a-140c relative to the product advancement surface 115 of the conveyor 110, but it will be appreciated that the positions of the image capture devices 140a-140c are shown by way of example only, and may be varied as needed. In some embodiments, the speed of the conveyor 110 and the locations of the image capture devices 140a-140c of the system 100 are chosen such that the system 100 is able to detect damage/defects sized at least 0.15 mm on the surface of the products 190. However, in certain implementations, the system 100 may be set up such that damage/defects that are less than 0.15 in length/width may be detected by the system 100.

With reference to FIG. 5, the example computing device 150 usable with example systems and methods described herein may include a control circuit 510 including a programmable processor (e.g., a microprocessor or a microcontroller) electrically coupled via a connection 515 to a memory 520 and via a connection 525 to a power supply 530. The control circuit 510 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

In some embodiments, the control circuit 510 (for example, by using corresponding programming stored in the memory 520 as will be well understood by those skilled in the art) carries out one or more of the steps, actions, and/or functions described herein. In some embodiments, the memory 520 may be integral to the processor-based control circuit 510 or can be physically discrete (in whole or in part) from the control circuit 510 and non-transitorily stores the computer instructions that, when executed by the control circuit 510, cause the control circuit 510 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

In the illustrated embodiment, the control circuit 510 of the computing device 150 is also electrically coupled via a connection 535 to an input/output 540 that can receive signals from, for example, from the image capture devices 140a-140c, electronic database 160, and/or from another electronic device (e.g., an electronic device of a worker of the retailer or a mobile electronic device of a customer of the retailer). The input/output 540 of the computing device 150 can also send signals to other devices, for example, a signal to the electronic database 160 to obtain or transmit for storage images of products 190 and/or of the conveyor 110 captured by the image capture devices 140a-140c and/or to retrieve and/or update a reference model image associated with a product 190. For example, in some embodiments, the control circuit 510 is programmed to process the images captured by the image capture devices 140a-140c and to extract raw image data and metadata from the images, and to cause transmission of the data extracted from the images to the electronic database 160 for storage. In some embodiments, the image capture devices 140a-140c may capture images of the products 190 and transmit the captured images to an image processing service, which may be cloud-based, or which may be installed on/coupled to the computing device 150 and executed by the control circuit 510.

In certain embodiments, each image capture device 140a-140c captures image of the product 190 traveling on the product advancement surface 115 of the conveyor 110, and to compress the captured image prior to transmitting the compressed image to the electronic database 160 for storage and/or to the computing device 150 for later processing/analysis by the control circuit 510 of the computing device 150. This image compression by the image capture devices 140a-140c advantageously reduces the storage requirements of the electronic database 160 (as compared to capturing and transmitting full-size images), and also reduces the processing power required of the control circuit 510 to process the compressed image (as compared to the full-size image) when attempting to determine the presence of a product 190 and/or identity of the product 190 and/or a defect on a surface of the product 190 in the image captured by the image capture devices 140a-140c.

The processor-based control circuit 510 of the computing device 150 shown in FIG. 5 is electrically coupled via a connection 545 to a user interface 550, which may include a visual display or display screen 560 (e.g., LED screen) and/or button input 570 that provide the user interface 550 with the ability to permit an operator of the computing device 150 (e.g., worker at a the retail facility (or a worker at a remotely-located control center) tasked with monitoring the quality and defect severity of the products 190 received by a facility (e.g., distribution center, store, etc.) to manually control the computing device 150 by inputting commands via touch-screen and/or button operation and/or voice commands. Possible commands may, for example, cause the computing device 150 to transmit of a notification signal indicating that a product 190 is of a quality acceptable to the retailer or is of a quality that is not acceptable to the retailer.

In some embodiments, the manual control by an operator of the computing device 150 may be via the user interface 550 of the computing device 150, via another electronic device of the operator, or via another user interface and/or switch, and may include an option to modify/update the reference model image data generated by the control circuit 510 using a machine learning model 555 (e.g., deep neural network) with respect to the images of the products 190 analyzed by the system 100. In some embodiments, the user interface 550 of the computing device 150 may also include a speaker 580 that provides audible feedback (e.g., alerts) to the operator of the computing device 150. It will be appreciated that the performance of such functions by the control circuit 510 is not dependent on a human operator, and that the control circuit 510 may be programmed to perform such functions without a human operator.

In some embodiments, the control circuit 510 of the computing device 150 is programmed to control various elements of the housing 120, for example, the image capture devices 140a-140c and/or the lighting elements 130a-130c. For example, the control circuit 510 may be programmed to send one or more signals to instruct the lighting elements 130a-130c to turn on and off and/or to illuminate the interior 122 of the housing 120 with a specified brightness/intensity that would enhance the quality of the images taken by the image capture devices 140a-140c. Similarly, the control circuit 510 may be programmed to send one or more signals to instruct the image capture devices 140a-140c to turn on and off and/or to capture one or more images of one or more products 190 moving on the product advancement surface 115.

In certain implementations, the control circuit 510 of the computing device 150 receives an input indicating that a product 190 located on the product advancement surface 115 of the conveyor 110 is positioned within a field of view 141 (and, preferably, at the center 143 of the field of view 141) of the image capture devices 140a-140c. As mentioned above, such an input may be a signal including product location data received from a product detector sensor 145 that indicates the presence of the product 190 within the field of view 141 of the image capture devices 140a-140c. In some embodiments, in response to receipt of such an input, the control circuit 510 is programmed to identify a type and/or a size of the product 190 positioned within the field of view 141 of the image capture devices 140a-140c. Then, based on the identification of the type and/or size of this product 190, the control circuit 510 is programmed to adjust (e.g., by sending a control signal) a lens of each of the image capture devices 140a-140c to a focus that is complementary to the type and/or size of the product 190 that was detected in the field of view of the image capture device 140a-140c.

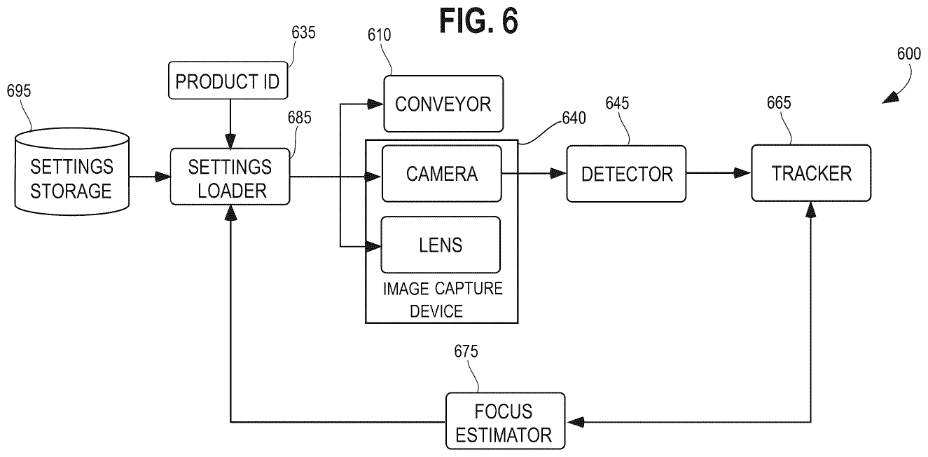

With reference to FIGS. 5 and 6, in some embodiments, the control circuit 510 is executes a tracker 665 (see FIG. 6 depicting an example system 600), which may be a separate physical device that is communicatively coupled to the control circuit 510, or built directly into the physical structure of the control circuit 510, and which processes an image captured by an image capture device 640 to detect, in this image, a product 190 moving on the conveyor 610. In addition, in certain embodiments, the tracker 665, when activated, generates a digital image track that depicts movement of the product 190 detected in the image captured by the image capture device 640 over a certain period of time during the movement of the product 190 on the conveyor 610. In one further embodiment, the control circuit 510 executes the tracker 665 to process the image captured by the image capture device 640 to define a size and/or shape of the product 190 detected in the image captured by the image capture device 640 during the movement of the product 190 on the conveyor 110.

With reference to FIGS. 5 and 6, in some embodiments, the control circuit 510 processes (e.g., correlates) the product location data generated by the product detector 645 with the digital image track generated by the tracker 665 in association with a given product 190 moving on the conveyor 110. In one embodiment, this processing/correlation of the product location data generated by the product detector 645 and the digital image track generated by the tracker 665 in association with a given product 190 moving on the conveyor 110 results in the control circuit 510 determining when/if the product 190, during its movement on the conveyor 110, is located at the center (see vertical line 143 in FIG. 3) of the field of view (see dashed rectangle 141 in FIG. 3) of the one or more image capture devices 640. In some embodiments, this determination by the control circuit 510 leads to the control circuit 510 causing an adjustment of the focus of the image capture devices 640 and/or causing the image capture devices 640 to snap one or more images of the product 190.

With reference to FIG. 4, in some embodiments, the control circuit 510 is programmed to obtain from the electronic database 160, directly, or via a cloud-based computer vision model application programming interface (API), one or more images of a product 190 captured by the image capture devices 140a-140c while the product 190 was positioned on the product advancement surface 115 of the conveyor 110 (and, optionally, when the product was determined by the control circuit 510 to be located within a center 143 of the field of view 141 (see FIG. 3) of the image capture devices 140a-140c. In certain implementations, the control circuit 510 is processes the image(s) captured by the image capture devices 140a-140c to detect and identify each individual product 190 in the image. For example, in some embodiments, the control circuit 510 processes the images captured by the image capture devices 140a-140c and/or digital image tracks created by the tracker 665 to detect the identity and the overall size and shape of each product 190 captured in the image/track. In some embodiments, the control circuit 510 is programmed to detect the presence of a product 190 in the image by detecting an obstruction of a portion of the product advancement surface 115 of the conveyor 110, which would be indicative of a product 190 having a size matching the obstruction to be present on the product advancement surface 115 of the conveyor 110 in the image processed by the control circuit 510.

With reference to FIG. 6, the example system 600 includes a settings loader 685. The settings loader 685 obtains various camera and/or lens settings from a settings storage 695 (which may be separate from the electronic database 160 or incorporated into the electronic database 160), and to load the camera and/or lens settings obtained from the settings storage 695 into one or more image capture device 640, which then adjusts the settings of the image capture devices 640 and causes the image capture device 640 to capture images of the products 190 moving on the conveyor 610 according to the camera/lens settings loaded into the image capture device 640 by the settings loader 685.

In certain implementations, the control circuit 510 is programmed to transmit electronic data indicative of a product ID 635 to the settings loader 685. Then, the settings loader 685 loads, from the settings storage 695, camera/lens settings complementary to (predetermined for) the received product ID 635, into the image capture devices 640. These camera/lens settings, which are complementary to the product ID 635, optimize the positioning and/or focus of the lens of the image capture device 640 specifically for this product 190 (e.g., blueberry, strawberry, banana, apple, cucumber, watermelon, etc.), which in turn enables the image capture device 640 to capture an optimized (and maximally focused) image of the product 190 while the product 190 moving on the conveyor 610.

In other words, when the settings loader 685 loads (from the settings storage 695) camera/lens settings into the image capture device 640 based on a received product ID 635 that indicates that the product is a blueberry, the settings loaded from the settings storage 695 by the settings loader 685 into the image capture device 640 would be complementary to a very small product having the size of typical blueberry (e.g., distance, zoom, focus, color, contrast, depth of field, shutter speed, aperture, etc. of the image capture device 640 may be adjusted accordingly to ensure an image of the blueberry having the highest possible quality). On the other hand, when the image capture device 640 is loaded by the settings loader 685 with camera/lens settings based on a received product ID 635 that indicates that the product 190 traveling on the conveyor 110 is a watermelon, the settings loaded (from the settings storage 695) by the settings loader 685 into the image capture device 640 would be complementary to a very large product having the size of a typical watermelon (e.g., distance, zoom, focus, color, contrast, depth of field, shutter speed, aperture, etc. of the image capture device 640 may be adjusted accordingly to ensure an image of a watermelon having the highest possible quality).

With reference to FIGS. 5 and 6, in some embodiments, the control circuit 510 executes a focus estimator 675, which may be a separate physical device that is communicatively coupled to the control circuit 510, or built directly into the physical structure of the control circuit 510, and which processes/correlates the product location data generated by the product detector 645 and the digital image tracks generated by the tracker 665 in association with a given product 190 moving on the conveyor 110. In one embodiment, this processing/correlation, by the focus estimator 675, results in the focus estimator 675 evaluating the focus of the lens of the image capture devices 140a-140c aimed at the product 190, determining a position of the lens of each of the image capture devices 140a-140c that results in the product 190 appearing in the resulting digital image in a maximum focus, and associating the determined position of the lens of each of the image capture devices 140a-140c that results in the product 190 appearing in the resulting digital image in a maximum focus with the product 190 appearing in the digital image track. In other words, the focus estimator 675 of the example system 600 generally performs the function of a focus sweeper that sweeps through an available focus range of each image capture device 140a-140c to find the point of best focus on a product 190 when the product is located at the center 143 of the field of view 141 of the image capture devices 140a-140c at a time when the product is being conveyed on the product advancement surface 115 of the conveyor 110 (or at a time when the product is located on a product support surface that does not move).

This processing by the focus estimator 675 advantageously results in the creation of lens focus settings for each of the image capture devices 640 that are specific to each product 190 analyzed by the system 600. In some embodiments, the focus estimator 675 to transmits (e.g., over a network 170, see FIG. 4) the camera/lens settings associated with specific products 190 (and determined to be optimal for taking digital photographs of this product 190 via the image capture devices 640 while the products are moving on the conveyor 610) to the electronic database (in this case, settings storage 695) for storage and future retrieval by the settings loader 685. As such, when a given product 190 is being analyzed by the system 600, the settings loader 685 of the system 600 would not load generic (i.e., default) camera/lens settings from the settings storage 695 into the image capture devices 640, but would instead camera/lens settings from the settings storage 695 that are most complementary to this specific product 190, and which would generate digital images of the product 190 that are of optimal quality to enable the system 600 to perform a highly reliable inspection of these digital images to determine whether the surface of the product 190 in the images contains any defects. It will be appreciated that each of the detector 645, tracker 665, focus estimator 675, and settings loader 685 may be implemented as instructions stored on a machine readable medium and executed by a processor and/or as circuitry such as an application specific integrated circuit (ASIC).

An example algorithm/logic flow that may be utilized by the control circuit 510 via the focus estimator 675 to calibrate the settings (and, more specifically, focus) of an image capture device 640, will now be described. It will be appreciated that this is just an example way to calibrate/optimize the settings of an image capture device 640 with respect to a given product 190, and that the control circuit 510 may be programmed to perform this calibration in one or more alternative ways.
1. Start;
2. Load generic (i.e., default) settings into image capture device 640 (in this step, the generic settings for the image capture device 640 may be obtained from the settings storage 695 by the settings loader 685);
3. Apply settings to camera and lens (in this step, the generic settings for the image capture device 640 that were obtained by the settings loader 685 from the settings storage 695 are loaded into the image capture device 640);
4. Start conveyor (here, the control circuit 510 may transmit a control signal to the conveyor control unit 117 (see FIG. 1), which in response to receipt of this control signal, causes the product advancement surface 115 of the conveyor 110 to move in a given direction);
5. Detect objects using an object detector (in this step, the product detector sensor 145 may detect the presence and/or location of a product 190 on the conveyor 110);
6. If detected object is not in the center of field of view, go to step 5 (here, if the control circuit 510 determines that the product 190 detected by the product detector sensor 145 is not located at the center (see vertical line 143 in FIG. 3) of the field of view (see dashed rectangle 141 in FIG. 3) of the image capture devices 140a-140c, the routine returns to back to step 5 until the control circuit 510 determines that the product 190 detected by the product detector sensor 145 is located at the center 143 of the field of view 141 of the image capture devices 140a-140c);
7. Stop conveyor (here, the control circuit 510 may transmit a control signal to the conveyor control unit 117 (see FIG. 1), which in response to receipt of this control signal, causes the product advancement surface 115 of the conveyor 110 to stop);
8. Set focus position to maximum (in this step, the control circuit 510 determines the position of the lens of each of the three image capture devices 140a-140c to capture a maximum focus image of the product 190 located at the center of the field of view 141 of the image capture devices 140a-140c);
9. Move lens to focus position and capture image (in this step, the control circuit 510 transmits a control signal to each of the three image capture devices 140a-140c to cause the lens of each of the three image capture devices 140a-140c to move to the focus position determined by the control circuit 510 to result in a maximally focused photograph of the product 190. The lens of each of the three image capture devices 140a-140c may be moved in a variety of different ways, for example, as a result of the lens being digitally moved into a desired focus, the lens physically rotated using a motor, the image capture device 140-140c itself being physically moved (via a motor or otherwise), etc.)
10. Store the image (in this step, each of the three image capture devices 140a-140c, after snapping a digital image of the product 190, transmits (e.g., over the network 170) the digital image to the electronic database 160);
11. Decrement lens position by delta; (here, the control circuit 510 causes the lens of each image capture device 140a-140c to move in a negative direction (e.g., closer to the camera body) by a predefined distance;
12. If lens position is larger than minimum lens position, go to step 9; (here, the control circuit 510 determines whether the current position of the lens is farther away from the camera body of the image capture device 140a-140c than the closest possible focus distance (i.e., the minimum lens position, which is the point at which the lens can no longer focus on closer objects because the elements cannot physically move any closer to the sensor);
13. Evaluate focus on each position and find the position with maximum focus; (here, the control circuit 510 determines, which of the different lens positions of the image capture device 140a-140c results in an image with the maximum focus);
14. Store the position and the product name in the settings; (here, the control circuit 510, after determining which of the different lens positions of the image capture device 140a-140c results in an image with the maximum focus, identifies a lens position of the image capture device 140a-140c that results in a maximum focus image of a given product 190, associates this lens position with the product 190 as being complementary to this product 190, and transmits electronic data indicating an association between the identified product 190 and the lens setting of the image capture device 140a-140c that was determined to be most complementary (i.e., optimal) for achieving a digital image of the product 190 with a maximum focus; and
15. Stop (here, the process stops).

In some embodiments, the electronic database 160 stores reference model image data associated with previously-identified products 190 and representing digital images of the products 190 (when in an undamaged condition) that were taken at maximum focus when the products 190 were located at the center 143 of the field of view 141 of the image capture devices 140a-140c. In certain embodiments, after a presence of a product 190 in the image is detected, the control circuit 510 is programmed to query the electronic database 160 to obtain a reference model image data associated with previously-identified products 190 (depicting the products 190 when in an undamaged condition and when photographed at the center 143 of the field of view 141 of the image capture devices 140a-140c), and to correlate the depiction of the product 190 detected in the image to the reference model data obtained from the electronic database 160 to determine whether the product 190 detected in the image matches a product reference model image obtained from the electronic database 160. If a match is found, the control circuit 510 is able to identify the product 190 detected in the image.

In some embodiments, the control circuit 510 is programmed to use the images of various products 190 newly-captured by the image capture devices 140a-140c and the reference model images obtained from the electronic database 160 to train machine learning and computer vision models that facilitate a more precise detection of products at the center 143 of the field of view 141 of the image capture devices 140a-140c, a more precise identification of products 190 in the images, and a more precise detection of defects on the surfaces of the products 190 in the images. In some embodiments, a machine learning model may be, for example, a convolutional neural network (CNN), recurrent neural network (RNN), long short-term memory (LSTM), feedforward neural network (FFNN), neural architecture learning, transfer learning, Google AutoML, etc. It will be appreciated that other suitable object detection algorithms may be used.

In certain implementations, the control circuit 510 is programmed to analyze the image data captured by the image capture devices 140a-140c of a product 190 (e.g., an apple) moving on the product advancement surface 115 of the conveyor 110 and being assessed for its quality, and to analyze the reference model image data stored in the electronic database 160 in association with the same type product 190 (i.e., same kind of apple) to identify a type of a defect/damage present on the surface product 190 being currently assessed, and to output an indication identifying the type of defect detected as being present on the product 190 being assessed. For example, in some embodiments, the damage/defects in a perishable product 190 such as an apple that may be detected by the control circuit 510 via the machine learning/computer vision model 155 may include but are not limited to cracks, dents, scars, shriveled ends damage, sunken area damage, decay damage, discoloration, and the like.

In some embodiments, the reference model image data for various products 190 detected in the images previously captured by the image capture devices 140a-140c are stored in the electronic database 160 for future retrieval by computing device 150 when processing incoming actual images newly-captured by the image capture devices 140a-140c. Since they are generated via computer vision/neural networks trained on hundreds/thousands of images of the products 190, the reference model image data models generated by the computing device 150 (and/or a cloud-based computer vision API) and stored in the electronic database 160 facilitate faster and more precise detection/classification/identification of the products 190, as well as a more precise detection of a type of a defect on a surface of a product 190 in subsequent images newly-captured by the image capture devices 140a-140c.

In one embodiment, the control circuit 510 is programmed to obtain (from the image capture devices 140a-140c or the electronic database 160) image data representing one or more images of one or more products 190 captured by the image capture devices 140a-140c while the products 190 are moving on the product advancement surface 115 of the conveyor 110. After that, the control circuit 510 is programmed to obtain, from the electronic database 160, the reference model image data and to analyze the actual image data and the reference model image data to identify the one or more products 190 in the image, and to detect one or more defects present on the surface of the one or more products 190 as well as the size (e.g., area) of each detected defect, and to output a notification (e.g., on a display screen 560 of the computing device 150, on a display screen of a portable electronic device of a worker, etc.) indicating whether or not the product 190 is of a quality that is acceptable to the retailer for offering for sale to the consumers.

In some embodiments, control circuit 510 of the computing device 150 is programmed to analyze the image data of the product 190 being assessed for quality and the reference image data stored in the electronic database 160 to detect exterior contours of the product 190 in order to identify the size (e.g., length, width, height, arc, etc.) of the product 190. For example, the control circuit 510 may process the image data to detect a series of pixelated dots that represent the contours of the product 190 that was captured in an image by an image capture device 140a-140c. In some embodiments, the control circuit 510 is programmed to determine a scale factor and a number of pixels representing the contours of the product 190, and to then translate the number of pixels representing the contours of the product 190 to actual dimensions (in inches, centimeters, etc.) of the product 190.

As mentioned above, in some embodiments, the control circuit 510 is programmed to obtain image data representing one or more images of one or more products 190 captured by the image capture devices 140a-140c and process the obtained images to determine whether the images contain a depiction of a product 190 traveling on the conveyor 110. Then, in response to a determination by the control circuit 510 that the obtained image contains a depiction of the product 190, the control circuit 510 is programmed to further process this image to determine whether this product 190 is located at the center 143 of the field of view 141 of the image capture devices 140a-140c, adjust the settings (e.g., focus, etc. as discussed above) of the image capture devices 140a-140c, identify the product 190 (e.g., an apple) present in the at least one image (and, optionally, to detect the size of the identified product 190) and to detect one or more defects on a surface of the identified product 190 (and, optionally, to detect the size of the defect of the identified product 190).

In certain embodiments, the processor of the control circuit 510 of the computing device 150 is programmed to extract raw data from an image of a product 190 (e.g., an apple) captured by an image capture device 140a-140c while the product 190 travels on the conveyor 110 through the housing 120, and to process this extracted raw data by employing the trained machine learning/computer vision model 155 and/or transfer learning in conjunction with class activation maps (CAMs), resulting in an image that visually identifies the pixels of the original image that contribute most to a damage/defect feature (e.g., scars, cracks, dents, shriveled ends damage, sunken area damage, decay damage, discoloration, etc.) of a product 190 being analyzed. In some embodiments, the control circuit 510 extracts each defect identified on the surface of the product 190 and calculates the area of the defect. In one embodiment, the control circuit 510 generates a class activation heat map of the image of the product 190, localizing the defects detected on the surface of the product 190 as a result of processing the image of the product 190.

In certain embodiments, after obtaining/generating a class activation heat map, the control circuit 510 processes this heat map using a binarization technique to obtain/determine the pixels associated with a detected defect (i.e., scars) on the surface of the product 190. Generally speaking, image binarization processing by the control circuit 510 may include converting color scale images into black and white (0 and 1), thereby providing sharper and clearer contours of various objects (product 190, defects (e.g., scars, cracks, sunken areas, etc.) on the product 190) detected in the image, and improving the precision of the machine learning/computer vision-based model 155 with respect to the identification of defects on the surface of the products 190 in the images captured by the image capture devices 140a-140c. In some embodiments, after applying binarization, the control circuit 510 is programmed to apply a connected components algorithm to extend the defects outside of the CAM heat map. In one implementation, a reference scale is used when the original image of the product 190 is captured using the image capture devices 140a-140c, and the control circuit 510 is programmed to determine an area of each of the defects detected on a surface of the product 190 via the reference scale.

In certain embodiments, instead of employing class activation maps, the processor of the control circuit 510 of the computing device 150 is programmed to extract raw data from an image of a product 190 (e.g., apple, strawberry, cucumber, melon, watermelon, etc.) captured by an image capture device 140a-140c and to analyze this raw data by employing a trained machine learning/computer vision model 155 in conjunction with image segmentation techniques, resulting in an image that visually identifies the areas of the original image that correspond to a defect feature (e.g., sunken surface) of the product 190. Generally, image segmentation is the process of partitioning a digital image into multiple segments (e.g., sets of pixels or image objects) in order to simplify the original image into representation of an image into an image that makes it easier to detect and localize certain objects of interest (in this example, areas of scars, cracks, sunken surfaces, etc.) in the image. More precisely, image segmentation involves assigning a label to every pixel in an image such that pixels with the same label share certain characteristics, with the goal being to get a view of objects of the same class divided into difference instances. In one implementation, a reference scale is used when the original image of the product 190 is captured using the image capture devices 140a-140c, and the control circuit 510 is programmed to determine an area of each of the defects detected on a surface of the product 190 in the image generated via image segmentation via the reference scale.

In one embodiment, the electronic database 160 stores data representative of product severity thresholds for each type of product 190 (e.g., strawberries, bananas, tomatoes, grapes, apples, cucumbers, watermelons, etc.) being assessed for quality by the system 100. The product severity threshold is a defect/damage severity value that represents the maximum defect/damage severity value associated with a given product 190 that the retailer is willing to accept (due to local governmental regulations, the retailer's internal quality standards, etc.) for purposes of offering the product 190 to consumers. In some embodiments, the control circuit 510 is programmed to determine a size (e.g., area, length, width, etc.) of a defect present on a product 190 being assessed for quality, and to translate the size of the defect present on the product 190 into a defect severity level of the product 190. In some embodiments, the defect severity level directly corresponds to the size/area of the defect/damage detected on the surface of the product 190. In other words, in some embodiments, the smaller the defect/damage, the lower the defect severity level, and the larger the defect/damage, the higher the defect severity level.

In certain implementations, The control circuit 510 is also programmed to correlate the defect severity level determined for the product 190 to a predetermined threshold defect severity level for the product 190 that is stored in the electronic database 160. For example, in some embodiments, the control circuit 510 determines a defect severity level of the product 190 being assessed, then transmits a query to the electronic database 160 to obtain electronic data representing the threshold defect severity level for the product 190, and then correlates the defect severity level of the product 190 being assessed to the threshold defect severity level for the product 190 obtained from the electronic database 160. As used herein, the term “threshold defect severity level” refers to a value, which determines whether the product 190 is considered acceptable for sale to consumers or not.

In one implementation, when the defect severity level of the product 190 being assessed by the control circuit 510 is below the predetermined threshold defect severity level pre-assigned to the product 190, the control circuit 510 is programmed to output (to a display screen 560 of the computing device 150 or to a display of a portable electronic device of a worker of the retailer) a notification indicating that the product 190 is of acceptable quality and may be offered for sale to consumers. For example, when the defect severity level of the product 190 being assessed by the control circuit 510 is 4.6 while the predetermined threshold defect severity level pre-assigned to the product 190 is 5, the control circuit 510 is programmed to output a notification indicating that the product 190 is of acceptable quality to be offered for sale to the consumers.

Conversely, when the defect severity level of the product 190 being assessed by the control circuit 510 exceeds the predetermined threshold defect severity level pre-assigned to the product 190, the control circuit 510 is programmed to output (to a display screen 560 of the computing device 150 or to a display of a portable electronic device of a worker of the retailer) a notification (e.g., a “defective product” alert) indicating that the product 190 is of an unacceptable quality to be offered for sale to the consumers. For example, when the defect severity level of the product 190 being assessed by the control circuit 510 is 5.5 while the predetermined threshold defect severity level pre-assigned to the product 190 is 5, the control circuit 510 is programmed to output a notification (e.g., a visible and/or audible “defective product” alert) indicating that the product 190 is of an unacceptable quality to be sold to the consumers.

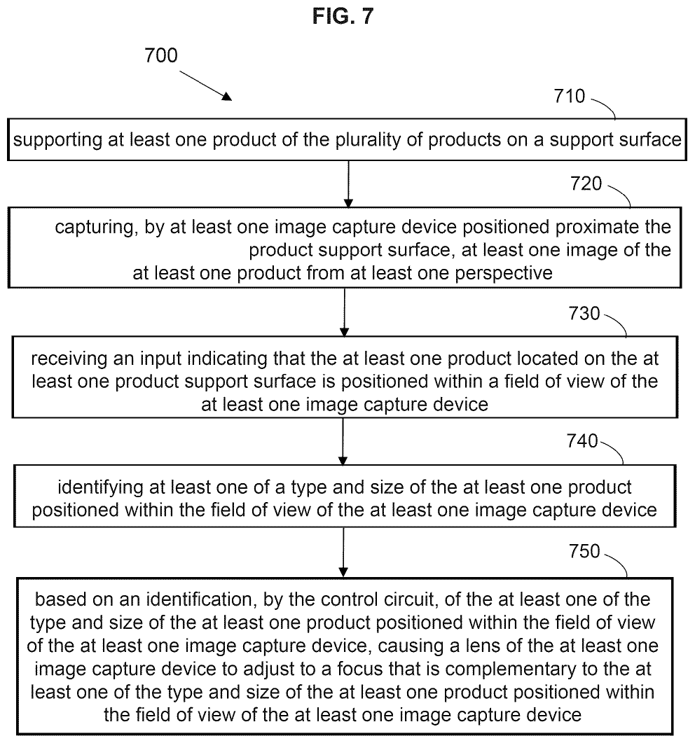

FIG. 7 is a flow chart depicting an example method 700 of calibrating a focus of image capture devices 140a-140c positioned to capture images of a plurality of products 190. The example method 700 includes supporting at least one product of the plurality of products on a support surface (step 710). As discussed above, in FIG. 1, the product support surface is a product advancement surface 115 of a conveyor 110, but in some implementations, the system 100 may not include a conveyor, and the products 190 may be positioned on a product support surface that does not move.

As pointed out above, the method 700 may include providing the product advancement surface 115 with markings 116 that indicate (to a human worker or a robotic hand) an exact location on the product advancement surface 115 of the conveyor 110 where a product 190 should be placed. As also pointed out above, the product advancement surface 115 may include a specialized texture or transparent stoppers designed to restrict the product 190 from moving/shifting from the marking 116 while moving on the product advancement surface 115 of the conveyor 110.

The example method 700 further includes capturing one or more images of the products 190 on the product advancement surface 115 of the conveyor 110 from at least one perspective by one or more image capture devices 140a-140c positioned proximate the product advancement surface 115 of the conveyor 110 (step 720). In some embodiments, as mentioned above, the control circuit 510 may be programmed to send one or more signals to instruct the image capture devices 140a-140c to continuously (e.g., non-stop at a pre-determined frame rate) or non-continuously (e.g., at a specific time set by the control circuit 510) capture one or more images of the product advancement surface 115 of the conveyor 110 during its movement.

In the embodiment shown in FIG. 7, the subsequent steps are performed by a processor-based control circuit 510 in communication with the image capture devices 140a-140c. In particular, step 730 of the method 700 involves the control circuit 510 receiving an input indicating that the product 190 located on the product support surface (see product advancement surface 115 of the conveyor 110 in FIG. 3) is positioned within a field of view (see dashed rectangle 141 in FIG. 3) of the image capture devices 140a-140c. Further, step 740 of the method 700 includes the control circuit 510 identifying at least one of a type and size of the product positioned within the field of view 141 of the image capture device 140a-140c.

As mentioned above, in certain implementations, the method 700 may include the control circuit 510 executing a focus estimator 675 that processes (e.g., correlate) product location data (indicative of detection and/or physical location of a product 190 on the conveyor 610) generated by the product detector 645 and the digital image track generated by the tracker 665 in association with a given product 190 moving on the conveyor 110 to determine the identity of the product 190 (in the example shown in FIG. 3, an apple) and to determine that this product 190 is located at the center (see vertical dashed line 143 in FIG. 3) of the field of view (see dashed rectangle 141 in FIG. 3) of the image capture devices 140a-140c, and to determine an optimal camera/lens (e.g., focus, etc.) setting that is complementary to this product 190 and would result in the image capture devices 140a-140c snapping a digital image of this product 190 in maximum focus and clarity. An example algorithm/logic flow that may be utilized by the focus estimator 675 to arrive at this result was described above. To that end, the method 700 includes, causing a lens of the image capture device 140a-140c to adjust to a focus that is complementary to the type and size of the product 190 positioned within the field of view 141 of the image capture device 140a-140c (step 750).

As discussed above, in certain embodiments, the method 700 may further include the control circuit 510 of the computing device 150 obtaining the images captured by the image capture devices 140a-140c over the network 170 and, to process the obtained images to determine whether the obtained images contain a depiction of a product 190 traveling on the conveyor 110. In certain embodiments, in response to a determination by the control circuit 510 that the obtained digital image contains a depiction of a product 190 on the product advancement surface 115 of the conveyor 110, the method 700 may further include further processing the image to identify the product 190 present in the image and to detect one or more defects on a surface of the product 190 identified in the image.

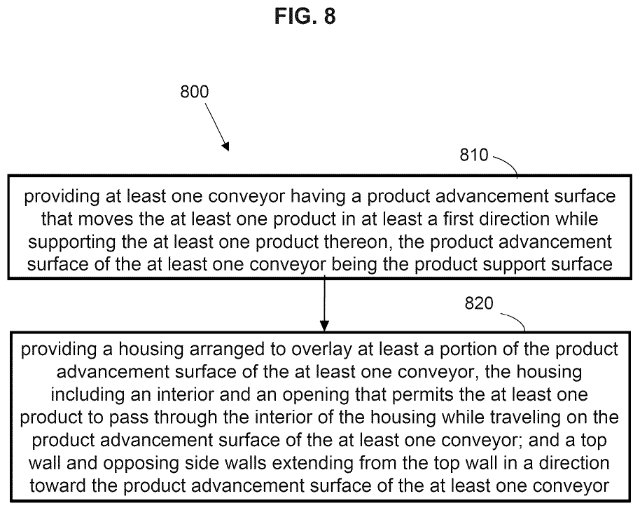

FIG. 8 is a flow chart depicting an example method 800 of calibrating a focus of image capture devices 140a-140c positioned to capture images of a plurality of products 190. The example method 800 includes providing at least one conveyor 110 having a product advancement surface 115 that moves at least one product 190 in at least a first direction while supporting the at least one product 190 thereon, the product advancement surface 115 of the at least one conveyor 110 being the product support surface (step 810. The method 800 further includes providing a housing 120 arranged to overlay at least a portion of the product advancement surface 115 of the at least one conveyor 110, the housing including an interior 122 and an opening 124 that permits the at least one product 190 to pass through the interior of the housing 120 while traveling on the product advancement surface 115 of the at least one conveyor 110, as well as a top wall 121 and opposing side walls 123, 125 extending from the top wall 121 in a direction toward the product advancement surface 115 of the at least one conveyor 110 (step 820).

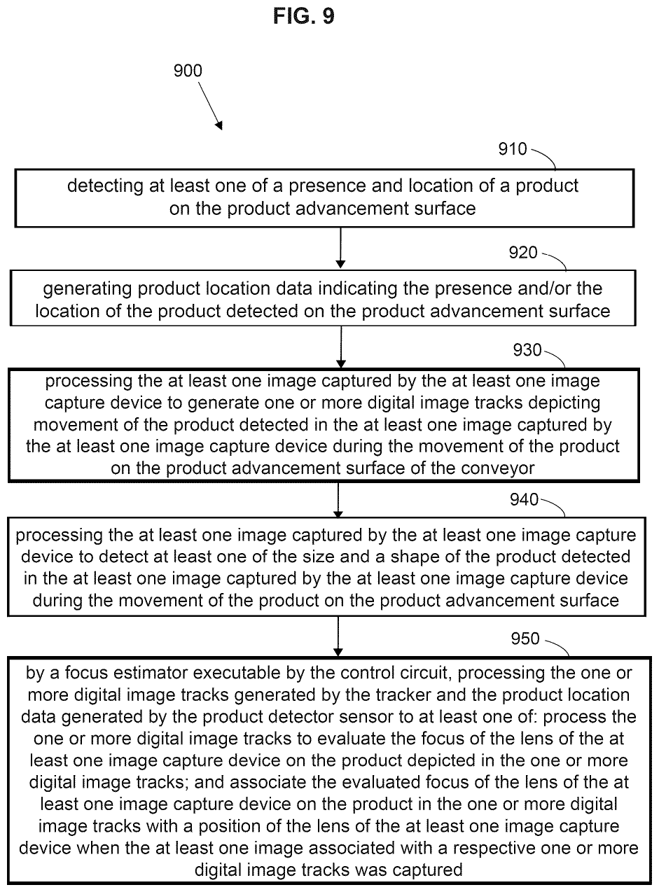

FIG. 9 is a flow chart depicting an example method 900 of calibrating a focus of image capture devices 140a-140c positioned to capture images of a plurality of products 190. The example method 900 includes detecting at least one of a presence and location of a product 190 on the product advancement surface 115 (step 910). The method 900 further includes generating product location data indicating at least one of the presence and the location of the product 190 detected on the product advancement surface 115 (step 920).

In the example illustrated in FIG. 9, the method 900 includes processing the at least one image captured by the at least one image capture device 140a-140c to generate one or more digital image tracks depicting movement of the product 190 detected in the at least one image captured by the at least one image capture device 140a-140c during the movement of the product 190 on the product advancement surface 115 of the conveyor 110 (step 930). Further, the example method 900 includes processing the at least one image captured by the at least one image capture device 140a-140c to detect at least one of the size and a shape of the product 190 detected in the at least one image captured by the at least one image capture device 140a-140c during the movement of the product 190 on the product advancement surface 115 (step 940).

In the example illustrated in FIG. 9, the method 900 further includes processing, by a focus estimator 675 executable by the control circuit 510, the one or more digital image tracks generated by the tracker 665 and the product location data generated by the product detector sensor 145 to at least one of: process the one or more digital image tracks to evaluate the focus of the lens of the at least one image capture device 140a-140c on the product 190 depicted in the one or more digital image tracks, and associate the evaluated focus of the lens of the at least one image capture device 140a-140c on the product 190 in the one or more digital image tracks with a position of the lens of the at least one image capture device 140a-140c when the at least one image associated with a respective one or more digital image tracks was captured (step 950).

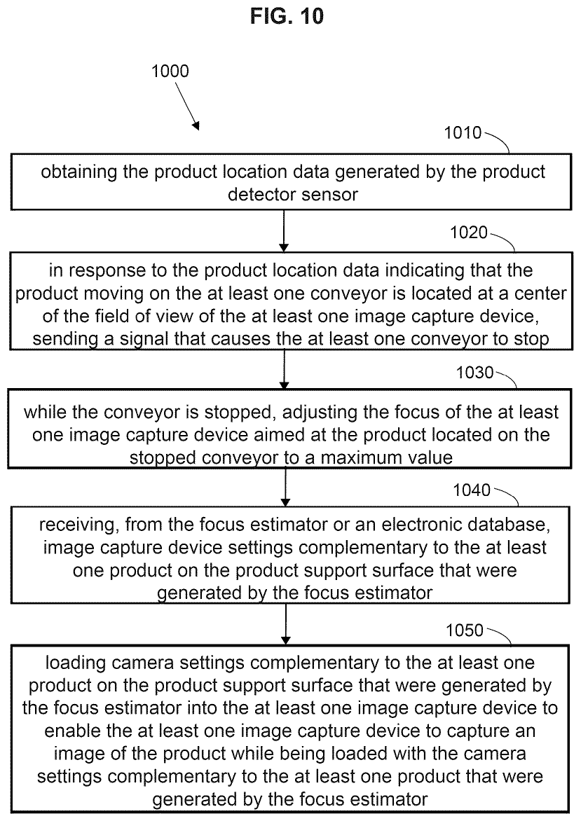

FIG. 10 is a flow chart depicting an example method 1000 of calibrating a focus of image capture devices 140a-140c positioned to capture images of a plurality of products 190. The example method 1000 includes, by the focus estimator 675, obtaining the product location data generated by the product detector sensor 145 (step 1010). In addition, the method 1000 includes, by the focus estimator 675, in response to the product location data indicating that the product 190 moving on the at least one conveyor 110 is located at a center of the field of view of the at least one image capture device, sending a signal that causes the at least one conveyor 110 to stop (step 1020). Further, the method 1000 includes, while the conveyor 110 is stopped and by the focus estimator 675, adjusting the focus of the at least one image capture device 140a-140c aimed at the product 190 located on the stopped conveyor 110 to a maximum value (step 1030).

In the example illustrated in FIG. 10, the method 1000 includes, by a settings loader 685 executable by the control circuit 510, receiving, from the focus estimator 675 or an electronic database 160, image capture device settings complementary to the at least one product 190 on the product support surface 115 that were generated by the focus estimator 675 (step 1040). The method 1000 further includes, by the settings loader 685, loading camera settings complementary to the at least one product 190 on the product support surface 115 that were generated by the focus estimator 675 into the at least one image capture device 140a-140c to enable the at least one image capture device 140a-140c to capture an image of the product 190 while being loaded with the camera settings complementary to the at least one product 190 that were generated by the focus estimator 675 (step 1050).

The above-described example embodiments of the methods and systems of assessing the quality of retail products advantageously provide a scalable automated solution for capturing images of retail products at an optimal time and collecting image data in association with the retail products and building/training machine learning models that provide for efficient and precise identification of a large number of retail products, as well as for efficient and precise detection of damage/defects on these retail products (especially perishable products such as fruits, vegetables, etc.). As such, the systems and methods described herein provide for an efficient and precise tool for a retailer to determine whether the products delivered to the retailer are acceptable for offering for sale to the consumers, thereby providing a significant cost in operation savings and the corresponding boost in revenue to the retailer.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A system for calibrating a focus of image capture devices positioned to capture images of a plurality of products, the system comprising:
a product support surface that supports at least one product of the plurality of products thereon;
at least one image capture device positioned proximate the product support surface to capture at least one image of the at least one product from at least one perspective; and
a control circuit including a programmable processor and communicatively coupled to the at least one image capture device, wherein the control circuit:
receives an input indicating that the at least one product located on the product support surface is positioned within a field of view of the at least one image capture device;
identifies at least one of a type and size of the at least one product positioned within the field of view of the at least one image capture device; and
based on an identification, by the control circuit, of the at least one of the type and size of the at least one product positioned within the field of view of the at least one image capture device, causes a lens of the at least one image capture device to adjust to a focus that is complementary to the at least one of the type and size of the at least one product positioned within the field of view of the at least one image capture device.

2. The system of claim 1, further comprising:
at least one conveyor having a product advancement surface that moves the at least one product in at least a first direction while supporting the at least one product thereon, wherein the product advancement surface of the at least one conveyor is the product support surface; and
a housing arranged to overlay at least a portion of the product advancement surface of the at least one conveyor, wherein the housing includes:
an interior and an opening that permits the at least one product to pass through the interior of the housing while traveling on the product advancement surface of the at least one conveyor; and
a top wall and opposing side walls extending from the top wall in a direction toward the product advancement surface of the at least one conveyor.

3. The system of claim 2, wherein:
the at least one image capture device includes a top image capture device, a first side image capture device, and a second side image capture device;
the top image capture device is coupled to the top wall of the housing;
the first side image capture device is coupled to a first one of the side walls of the housing located on a first side of the product advancement surface of the at least one conveyor; and
the second side image capture device is coupled to a second one of the side walls of the housing located on a second side of the product advancement surface of the at least one conveyor that is opposite to the first side.

4. The system of claim 2, further comprising a product detector sensor positioned proximate the product support surface, wherein the product detector sensor:
detects at least one of a presence and location of a product of the plurality of products on the product advancement surface of the at least one conveyor; and
generates product location data indicating at least one of the presence and the location of the product detected on the product advancement surface of the at least one conveyor.

5. The system of claim 4, further comprising a tracker executable by the control circuit, wherein the tracker:
processes the at least one image captured by the at least one image capture device to generate one or more digital image tracks depicting movement of the product detected in the at least one image captured by the at least one image capture device during the movement of the product on the product advancement surface of the at least one conveyor; and
processes the at least one image captured by the at least one image capture device to detect at least one of the size and a shape of the product detected in the at least one image captured by the at least one image capture device during the movement of the product on the product advancement surface of the at least one conveyor.

6. The system of claim 5, further comprising a focus estimator executable by the control circuit, wherein the focus estimator:
processes the one or more digital image tracks generated by the tracker and the product location data generated by the product detector sensor to at least one of:
process the one or more digital image tracks to evaluate the focus of the lens of the at least one image capture device on the product depicted in the one or more digital image tracks; and
associate the evaluated focus of the lens of the at least one image capture device on the product in the one or more digital image tracks with a position of the lens of the at least one image capture device when the at least one image associated with a respective one or more digital image tracks was captured.

7. The system of claim 6, wherein the focus estimator:
obtains the product location data generated by the product detector sensor;
in response to the product location data indicating that the product moving on the at least one conveyor is located at a center of the field of view of the at least one image capture device, send a signal that causes the at least one conveyor to stop; and
while the at least one conveyor is stopped, adjust the focus of the at least one image capture device aimed at the product located on the stopped at least one conveyor to a maximum value.

8. The system of claim 6, further comprising a settings loader executable by the control circuit, wherein the settings loader:
receives, from the focus estimator or an electronic database, image capture device settings complementary to the at least one product on the product support surface that were generated by the focus estimator; and
loads camera settings complementary to the at least one product on the product support surface that were generated by the focus estimator into the at least one image capture device to enable the at least one image capture device to capture an image of the product while being loaded with the camera settings complementary to the at least one product that were generated by the focus estimator.

9. The system of claim 1, further comprising a settings loader executable by the control circuit, wherein the settings loader:
obtains, from an electronic database, default image capture device settings; and
loads one or more of the default image capture device settings obtained from the electronic database into the at least one image capture device to enable the at least one image capture device to capture an image of the product while being loaded with the default image capture device settings.

10. The system of claim 1, wherein the control circuit:
identifies a size of a defect present on a surface of the at least one product captured in the at least one image, and to output an indication of the size of the defect identified on the surface of the at least one product captured in the at least one image;
identifies a type of defect present on a surface of the at least one product captured in the at least one image, and to output an indication of the type of the defect identified on the surface of the at least one product captured in the at least one image; and
in response to a determination by the control circuit that the surface of the at least one product contains a defect that exceeds a predetermined threshold defect severity level for the at least one product, generates and outputs a defective product alert.

11. A method for calibrating a focus of image capture devices positioned to capture images of a plurality of products, the method comprising:
supporting at least one product of the plurality of products on a product support surface;
capturing, by at least one image capture device positioned proximate the product support surface, at least one image of the at least one product from at least one perspective; and
by a control circuit including a programmable processor and communicatively coupled to the at least one image capture device:
receiving an input indicating that the at least one product located on the product support surface is positioned within a field of view of the at least one image capture device;
identifying at least one of a type and size of the at least one product positioned within the field of view of the at least one image capture device; and
based on an identification, by the control circuit, of the at least one of the type and size of the at least one product positioned within the field of view of the at least one image capture device, causing a lens of the at least one image capture device to adjust to a focus that is complementary to the at least one of the type and size of the at least one product positioned within the field of view of the at least one image capture device.

12. The method of claim 11, further comprising:
providing at least one conveyor having a product advancement surface that moves the at least one product in at least a first direction while supporting the at least one product thereon, wherein the product advancement surface of the at least one conveyor is the product support surface; and
providing a housing arranged to overlay at least a portion of the product advancement surface of the at least one conveyor, wherein the housing includes:
an interior and an opening that permits the at least one product to pass through the interior of the housing while traveling on the product advancement surface of the at least one conveyor; and
a top wall and opposing side walls extending from the top wall in a direction toward the product advancement surface of the at least one conveyor.

13. The method of claim 12, wherein:
the at least one image capture device includes a top image capture device, a first side image capture device, and a second side image capture device;
the top image capture device is coupled to the top wall of the housing;
the first side image capture device is coupled to a first one of the side walls of the housing located on a first side of the product advancement surface of the at least one conveyor; and
the second side image capture device is coupled to a second one of the side walls of the housing located on a second side of the product advancement surface of the at least one conveyor that is opposite to the first side.

14. The method of claim 12, further comprising, by a product detector sensor positioned proximate the product support surface:
detecting at least one of a presence and location of a product of the plurality of products on the product advancement surface of the at least one conveyor; and
generating product location data indicating at least one of the presence and the location of the product detected on the product advancement surface of the at least one conveyor.

15. The method of claim 14, further comprising, by a tracker executable by the control circuit:
processing the at least one image captured by the at least one image capture device to generate one or more digital image tracks depicting movement of the product detected in the at least one image captured by the at least one image capture device during the movement of the product on the product advancement surface of the at least one conveyor; and
processing the at least one image captured by the at least one image capture device to detect at least one of the size and a shape of the product detected in the at least one image captured by the at least one image capture device during the movement of the product on the product advancement surface of the at least one conveyor.

16. The method of claim 15, further comprising, by a focus estimator executable by the control circuit, processing the one or more digital image tracks generated by the tracker and the product location data generated by the product detector sensor to at least one of:
process the one or more digital image tracks to evaluate the focus of the lens of the at least one image capture device on the product depicted in the one or more digital image tracks; and
associate the evaluated focus of the lens of the at least one image capture device on the product in the one or more digital image tracks with a position of the lens of the at least one image capture device when the at least one image associated with a respective one or more digital image tracks was captured.

17. The method of claim 16, further comprising, by the focus estimator:
obtaining the product location data generated by the product detector sensor;
in response to the product location data indicating that the product moving on the at least one conveyor is located at a center of the field of view of the at least one image capture device, sending a signal that causes the at least one conveyor to stop; and
while the at least one conveyor is stopped, adjusting the focus of the at least one image capture device aimed at the product located on the stopped at least one conveyor to a maximum value.

18. The method of claim 16, further comprising, by a settings loader executable by the control circuit:
receiving, from the focus estimator or an electronic database, image capture device settings complementary to the at least one product on the product support surface that were generated by the focus estimator; and
loading camera settings complementary to the at least one product on the product support surface that were generated by the focus estimator into the at least one image capture device to enable the at least one image capture device to capture an image of the product while being loaded with the camera settings complementary to the at least one product that were generated by the focus estimator.

19. The method of claim 11, further comprising, by a settings loader executable by the control circuit:
obtaining, from an electronic database, default image capture device settings; and
loading one or more of the default image capture device settings obtained from the electronic database into the at least one image capture device to enable the at least one image capture device to capture an image of the product while being loaded with the default image capture device settings.

20. The method of claim 11, further comprising, by the control circuit:
identifying a size of a defect present on a surface of the at least one product captured in the at least one image, and to output an indication of the size of the defect identified on the surface of the at least one product captured in the at least one image;
identifying a type of defect present on a surface of the at least one product captured in the at least one image, and to output an indication of the type of the defect identified on the surface of the at least one product captured in the at least one image; and
in response to a determination by the control circuit that the surface of the at least one product contains a defect that exceeds a predetermined threshold defect severity level for the at least one product, generating and outputting a defective product alert.

21. A non-transitory computer-readable medium programmed with a computer-executable instructions for calibrating at least one image capture device proximate a product support surface to capture images of at least one product located on the product support surface from at least one perspective, wherein the instructions are executed by a control circuit to cause the control circuit to:
receive an input indicating that at least one product located on the product support surface is positioned within a field of view of the at least one image capture device;
identify at least one of a type and size of the at least one product positioned within the field of view of the at least one image capture device; and
based on an identification, by the control circuit, of the at least one of the type and size of the at least one product positioned within the field of view of the at least one image capture device, cause a lens of the at least one image capture device to adjust to a focus that is complementary to the at least one of the type and size of the at least one product positioned within the field of view of the at least one image capture device.
